(19) United States
(12) Patent Application Publication
(10) Pub. No.: US 2015/0075323 A1
(43) Pub. Date: Mar. 19, 2015

(54) TRANSMISSION WEAR PLATE

(71) Applicant: Exedy Globalparts Corporation, Belleville, MI (US)

(72) Inventor: Kyle House, Houston, TX (US)

(73) Assignee: Exedy Globalparts Corporation, Belleville, MI (US)

(21) Appl. No.: 14/472,467

(22) Filed: Aug. 29, 2014

Related U.S. Application Data
(60) Provisional application No. 61/879,242, filed on Sep. 18, 2013.

(51) Int. Cl. F16H 57/021

(52) U.S. Cl. CPC F16H 57/021; F16H 2057/0216
USPC 74/606 R

(57) ABSTRACT

A vehicle transmission includes a transmission pump body having a surface defining apertures, including an intake port, an exhaust port, and a drain back hole; a bell housing; and a steel wear plate disposed between the pump body surface and the bell housing, wherein the wear plate defines a plurality of apertures that mimic and correspond with the intake port, exhaust port and drain back hole of the pump body. The wear plate protects the bell housing from damage in the event of a catastrophic failure of a torque converter or transmission pump, without interfering with normal operation of the transmission.

### CROSS-REFERENCE TO RELATED APPLICATIONS

This application claims the benefit of U.S. Provisional Application No. 61/879,242, filed Sep. 18, 2013, which is incorporated herein by reference.

### FIELD OF THE DISCLOSURE

This disclosure relates to vehicle automatic transmissions and in particular to a vehicle automatic transmission that exhibits improved resistance to damage upon failure of an associated torque converter or transmission pump.

### BACKGROUND OF THE DISCLOSURE

Certain automatic transmissions often have a problem with torque converter and/or transmission pump failure. The torque converter, affixed to the rear of the vehicle's engine, is located in the front of the transmission. While the engine is running, the torque converter rotates the pump gear set of the transmission which creates the necessary hydraulic pressure that allows normal operation.

The pump gears are located in a machined cavity of a cast-iron housing which is located in a recess of an aluminum housing. These gears ride directly against the aluminum housing using inert transmission oil as lubricant.

When failure of the torque converter or pump occurs, debris from failed part(s) may cause serious damage to the pump assembly of the transmission. This debris will get caught in the spinning gears of the pump causing breakage of the gears. At this point, the torque converter is still turning with the engine and, in turn, is pulverizing the debris from both the failed torque converter and the now-failed pump gears.

### SUMMARY OF THE DISCLOSURE

Disclosed herein is a transmission pump wear plate that reduces damage to transmission components upon failure of the torque converter and/or the transmission pump.

The transmission wear plate is a sheet metal material that can be harder than the aluminum of the bell housing of a typical vehicle transmission, and is configured to mimic the pump stator surface. Specifically, the transmission wear plate is configured to define an intake port, an exhaust port, a drain back port and a center hole for passage of a splined stator tube and converter hub. The various ports and holes have shapes generally corresponding with those defined in the transmission pump mating surface of the aluminum bell housing.

The transmission pump wear plate can be positioned between the pump body that contains the pump gears and an aluminum bell housing in order to protect the bell housing from damage in the event of catastrophic failure of the torque converter and/or transmission pump, without interfering with normal operation of the transmission.

### BRIEF DESCRIPTION OF THE DRAWINGS

FIG. 1 is a front view of a transmission pump wear plate.

FIG. 2 is a front view of the recess for the pump body and gears of an aluminum bell housing of a vehicle transmission.

FIG. 3 is a perspective view of a cast iron pump body with damaged gears.

FIG. 4 is a perspective view of an intact (not damaged) cast iron pump body with pump gears.

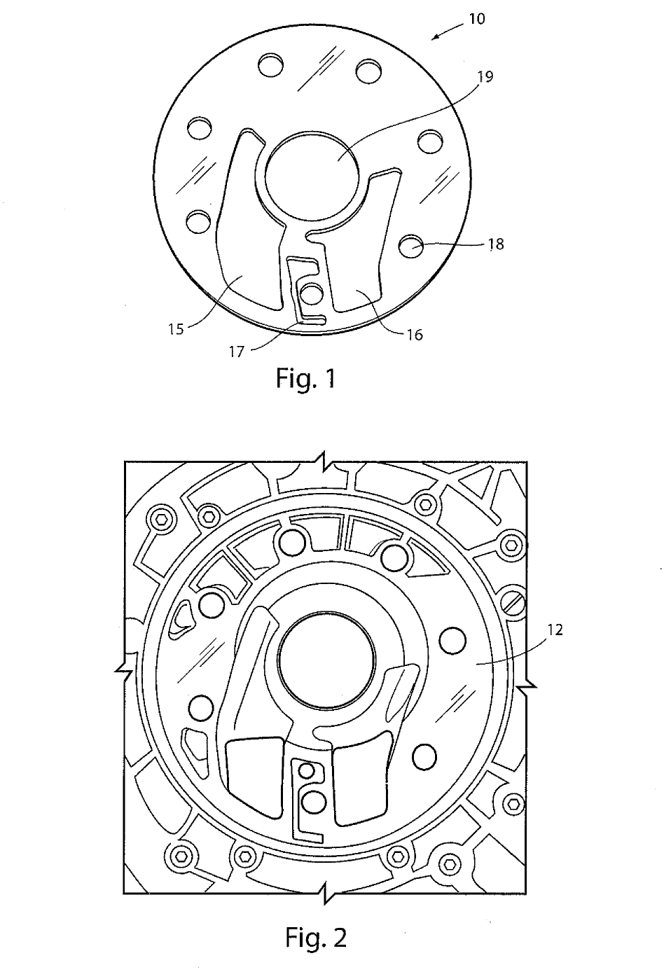

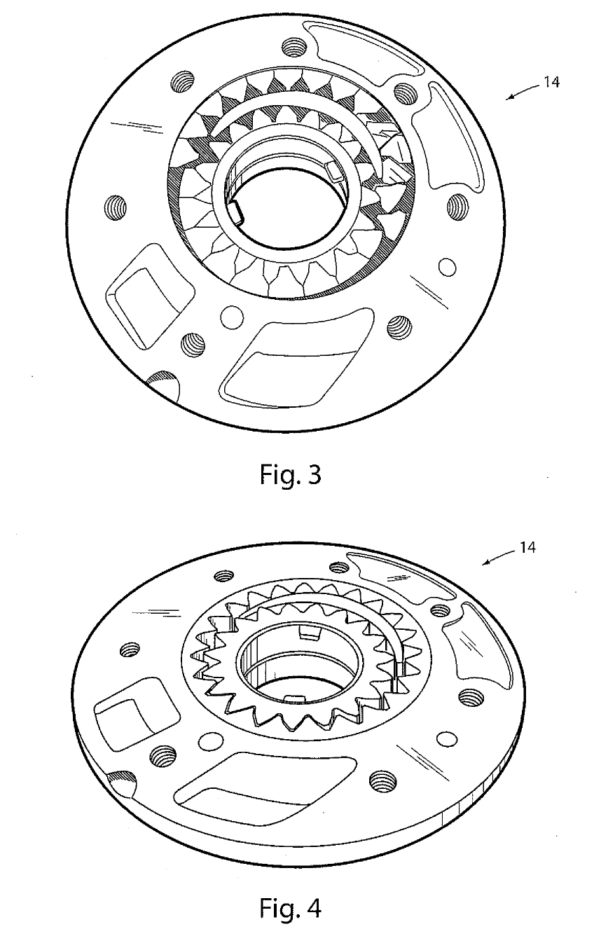

### DETAILED DESCRIPTION OF THE ILLUSTRATED EMBODIMENT

The wear plate 10 disclosed herein is designed to help prevent damage to the aluminum bell housing 12 (FIG. 2) of certain transmissions. Wear plate 10 has a circular shape.

The plate 10 is designed to be placed between the pump body 14, containing the pump gears, and the aluminum bell housing 12.

The plate 10 can be laser-cut or water jetted from a grade of steel which is considerably harder than the aluminum used for the bell housing 12. However, other materials can be used, with those materials having a hardness greater than aluminum being preferred.

The presence of the plate 10 protects the expensive bell housing 12 from damage should a catastrophic failure of the torque converter, and or pump body 14 occur.

The plate 10 is fabricated from sheet material (e.g., steel) to mimic or generally correspond to the shape and openings of the pump stator surface, including intake port 15, exhaust port 16 and drain back port 17, bolt holes 18, center hole 19 to allow passage of a splined stator support tube. The intake port 18, exhaust port 16 and drain back port 17 typically have irregular shapes (i.e., shapes that are not symmetrical). The center hole 19 typically has a circle shape. The bolt holes 18 are typically disposed adjacent a peripheral edge of plate 10, each located substantially an equal distance from the center of the plate.

The plate 10 can be made of materials other than steel provided that the material is sufficiently hard and of sufficient thickness to protect the bell housing 12.

The foregoing description of the specific embodiment of the invention have been presented for purposes of illustration and description. They are not intended to be exhaustive or to limit the claims to the precise forms disclosed, and obviously many modifications and variations are possible in light of the above teaching.

What is claimed is:

1. A transmission wear plate for a fluid pump of a transmission, comprising:
a sheet material defining a plurality of apertures, including a center aperture for a splined stator support tube, an intake port, an exhaust port, and a drain back hole.

2. A vehicle transmission having the plate of claim 1 disposed between a transmission pump body and a bell housing.

3. The vehicle transmission of claim 2, in which the intake port, exhaust port and drain back hole have different irregular shapes that generally conform with the shapes of corresponding apertures in a surface of the transmission pump body and bell housing.

4. The vehicle transmission of claim 2, in which the wear plate has a circle shape.

5. The vehicle transmission of claim 2, in which the center aperture has a generally circular shape.

6. The vehicle transmission of claim 2, in which the plurality of apertures include a plurality of bolt holes located adjacent a perimeter of the wear plate.

7. The vehicle transmission of claim 2, in which the sheet material is steel.

8. A vehicle transmission pump body having a surface defining apertures, including an intake port, an exhaust port, and a drain back hole;
a bell housing; and
a steel wear plate disposed between the transmission pump body surface and the bell housing, the steel wear plate defining a plurality of apertures, including a center aperture for a splined stator support tube, an intake port, an exhaust port, and a drain back hole, wherein the intake port, exhaust port and drain back hole defined by the wear plate mimic corresponding apertures in a surface of the transmission pump body and bell housing.

9. The vehicle transmission of claim 8, in which the wear plate has a circle shape.

10. The vehicle transmission of claim 8, in which the center aperture has a generally circular shape.

11. vehicle transmission of claim 8, in which the plurality of apertures include a plurality of bolt holes located adjacent a perimeter of the wear plate.
